(19) United States
(12) Patent Application Publication
(10) Pub. No.: US 2016/0110308 A1
(43) Pub. Date: Apr. 21, 2016

(54) TOPOLOGY OF CONNECTING TWO COMPUTATION DEVICES

(71) Applicants: Hong Fu Jin Precision Industry (WuHan) Co., Ltd., Wuhan (CN); Hon Hai Precision Industry Co., Ltd., New Taipei (TW)

(72) Inventor: Hung-Chi Huang, New Taipei (TW)

(21) Appl. No.: 14/516,215

(22) Filed: Oct. 16, 2014

(51) Int. Cl. G06F 13/40; G06F 13/42

(52) U.S. Cl. CPC G06F 13/4081; G06F 13/4282

(57) ABSTRACT

A linking topology of dock and client computation devices connecting with each other through two mated connectors is disclosed. Each computation device comprises an embedded controller therein. The dock computation device has a display. The embedded controllers communicate with each other to decide the use of a sensor in either the dock computation device or the client computation device as a sensor for the connected dock and client computation device in whole.

### FIELD

The present disclosure relates to a system for connecting two computation devices, and particularly to a topology regarding the decision of a main device and a slave device when one computation device is connected to another computation device and the use of sensors in the two computation devices.

### BACKGROUND

Various computation devices such as ultra small form-factor (USFF) computation devices such as thin client computers, PC (personal computer) boxes, all-in-one (AIO) computers, mobile computation devices, such as smart phones and tablet computers bring people a lot of convenience. Usually, a person owns several such devices, which are operated individually. Each mobile computation device/computer device has its display screen and motion sensor for the display screen, and sensors for cameras. The motion sensors and camera sensors have different specifications and operate individually even when two mobile computation devices/computer devices are connected together, whereby the display screens and camera thereof operate individually.

A seamless connection between two connected computation devices relies on a replacement of function of one sensor of one of the two connected computation devices by a corresponding sensor of the other one of the computation devices.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the present topology of connecting two computation devices together. Moreover, in the drawings, like reference numerals designate corresponding parts throughout the several views.

FIG. 1 is a diagrammatic view showing a topology of connection between two computer devices in accordance with a first embodiment of the present disclosure.

FIG. 2 is a diagrammatic view showing a topology of connection between two computer devices in accordance with a second embodiment of the present disclosure.

FIG. 3 is a diagrammatic view showing a topology of connection between two computer devices in accordance with a third embodiment of the present disclosure.

FIG. 4 is a flow chart showing operations of the two connected computer devices of any of FIGS. 1-3.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

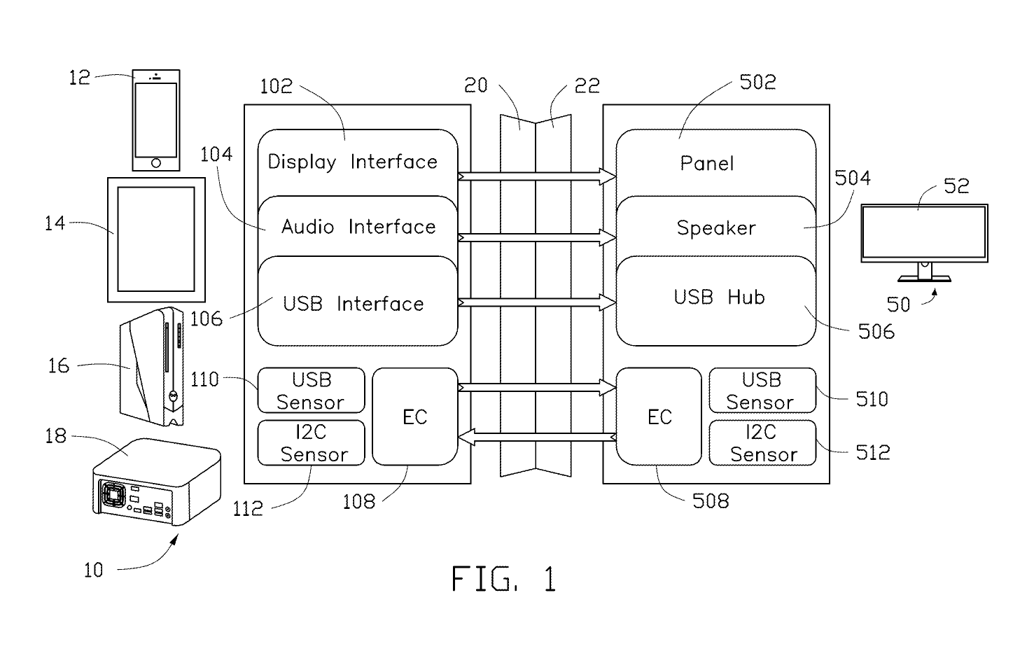

Referring to FIG. 1, a topology of connection of two computer devices in accordance with a first embodiment of the present disclosure is shown. The two computer devices include a first type computer device 10 and a second type computer device 50. The first type computer device 10 can be a smart phone 12, a tablet computer 14, a USFF (ultra small form factor) computer 16 or a PC (personal computer) box 18. The second type computer device 50 can be a monitor 52 such as an LCD display. The two computer devices 10, 50 are connected with each other through mating connectors 20, 22 which when mated can cause a display interface 102 of the first type computer device 10 to connect with a panel 502 of the second computer device 50, an audio interface 104 of the former to connect with a speaker 504 of the latter, a USB (universal serial bus) interface 106 of the former to connect with a USB hub 506 of the latter and an EC (embedded controller) 108 of the former to connect with an EC 508 of the latter. The display interface 102 is connected with the panel 502 in one way, whereby information can flow only from the display interface 102 to the panel 502, not vice versa. The audio interface 104 is connected with the speaker 504 in one way, whereby information can flow only from the audio interface 104 to the speaker 504, not vice versa. The USB interface 106 is connected with the USB hub 506 in one way whereby information can flow only from the USB interface 106 to the USB hub 506, not vice versa. The EC 108 is connected with the EC 508 in two ways whereby information can flow from the EC 108 to the EC 508 and vice versa.

Optionally, the first type computer device 10 can further comprise a USB sensor 110 and an LC (inter-integrated circuit) sensor 112. For example, when the first type computation device 10 is the smart phone 12, the first type computation device 10 can include two camera sensors (front and rear camera sensors) each of which is an I2C sensor, and a gravity sensor (G sensor) which is also an I2C sensor for detecting a motion of the first type computer device 10. The second type computer device 50 can also optionally further comprise a USB sensor 510 and an I2C sensor 512. In the first embodiment, since the second type computer device 50 which is the monitor 52 is purely a display device, there is no sensor in the second type computer device 50. Under such situation, the sensors of the first type computer device 10 are used as sensors for the connected first and second computer devices 10, 50. Nevertheless, the monitor 52 can be equipped with a camera for catching an image of a user of the monitor 52. In such case, the second type computer device 50 can have a camera sensor which can be a USB sensor or an I2C sensor. Under this situation, the front camera sensor of the first type computer device 10 is disabled, and the function thereof is replaced by the camera sensor of the second type computer device 50.

Since the second type computer device 50 has a computation capability far blew a computation capability of the first type computer device 10, when the first and second type computer devices 10, 50 are connected together to form a computer system, execution of computation of the system falls on the first type computer device 10. In the first embodiment, the USB sensor 110 or/and the I2C sensor ′112 of the first type computer device 10 is/are used as sensor(s) for the connected computer devices 10, 50.

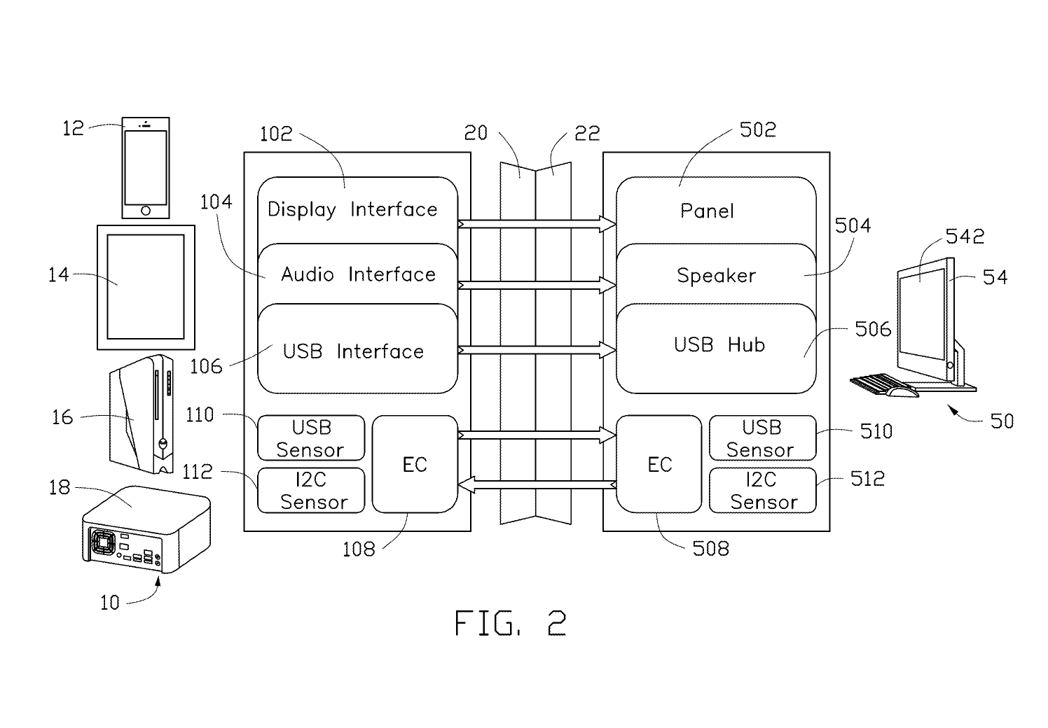

Referring to FIG. 2, a topology of connection of two computer devices in accordance with a second embodiment of the present disclosure is shown. The second embodiment is substantially the same as the first embodiment except that the second type computer device 50 is an AIO (all-in-one) computer 54. In the second embodiment, since the second type computer device 50 has a computation capability exceeding a computation capability of the first type computer device 10, when the first and second type computer devices 10, 50 are connected together to form a computer system, execution of computation of the system falls on the second type computer device 50.

Optionally, the first type computer device 10 can further comprise a USB sensor 110 and an I2C (inter-integrated circuit) sensor 112. For example, when the first type computation device 10 is the smart phone 12, the first type computation device 10 can include two camera sensors (front and rear camera sensors) each of which is an I2C sensor, and a gravity sensor (G sensor) which is also an I2C sensor. The second type computer device 50 can also optionally further comprise a USB sensor 510 and an I2C sensor 512. In the second embodiment, since the second type computer device 50 is an AIO computer 54 which includes a monitor 542, a camera for catching an image of a user of AIO computer 54 can be equipped in the monitor 552. In such case, the second type computer device 50 can have a camera sensor which can be a USB sensor. Under such situation, the front camera sensor of the first type computer device 10 is disabled, and the function thereof is replaced by the USB camera sensor in the monitor 542 of the AIO computer 54.

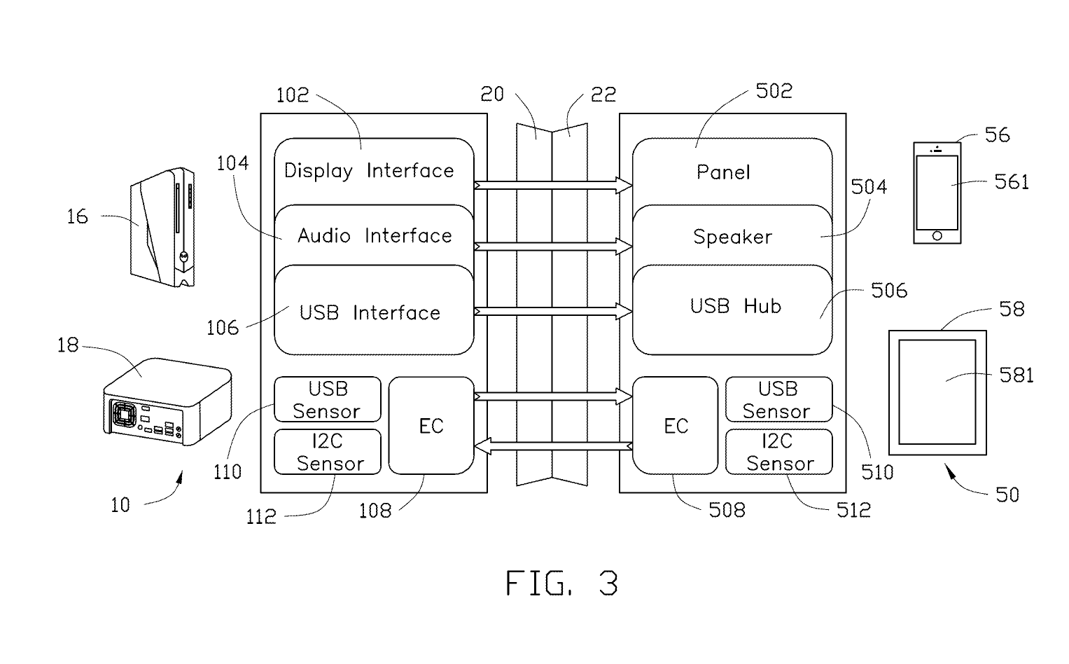

Referring to FIG. 3, a topology of connection of two computer devices in accordance with a third embodiment of the present disclosure is shown. The third embodiment is substantially the same as the first embodiment except that the first type computer device 10 is a USFF computer 16 or a PC box 18 and the second type computer device 50 is a smart phone 56 or a tablet computer 58. The smart phone 56 has a display 561. The tablet computer 58 has a display 581. In the third embodiment, since the first type computer device 10 has a computation capability exceeding a computation capability of the second type computer device 50, when the first and second type computer devices 10, 50 are connected together to form a computer system, execution of computation of the system falls on the first type computer device 10.

In the third embodiment, the I2C sensor 112 or/and the USB sensor 110 of the first type computer device 10, if any, is disabled, and its function is replaced by the USB sensor 510 and/or I2C sensor 512 of the second type computer device 50 if any.

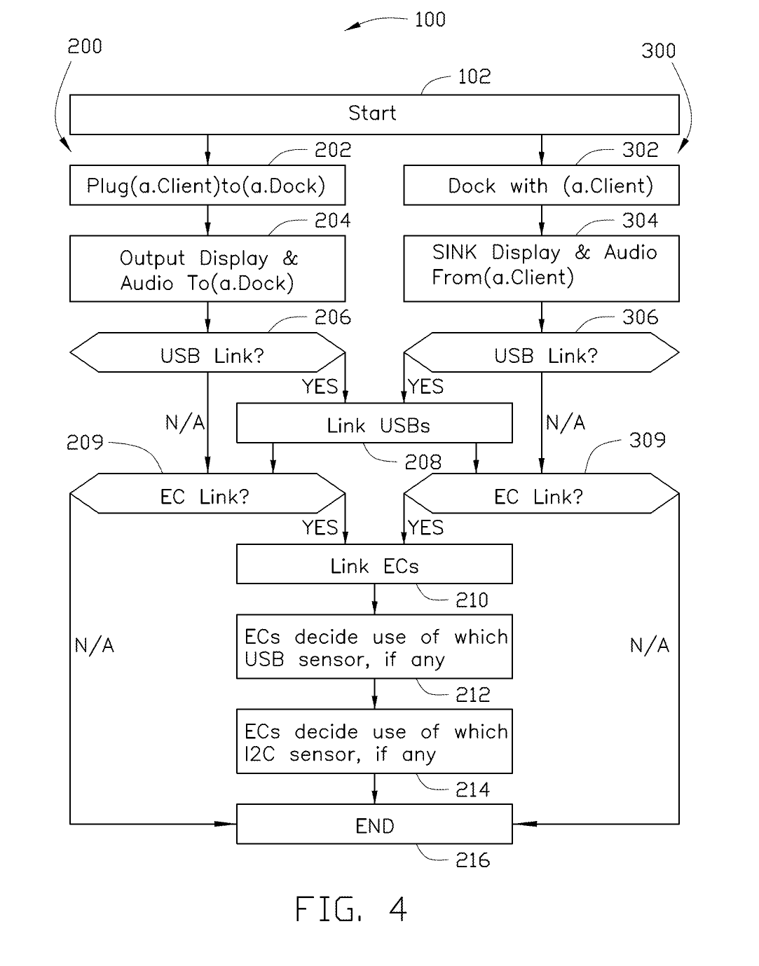

Referring to FIG. 4, operations 100 of the two computer devices 10, 50 when they are connected together are shown. The operations 100 begin at block 102 when the connectors 20, 22 of the first type and second type computer devices 10, 50 are mated together (also referring to FIG. 1). Then the operations 100 are divided into first operation 200 for the first type computer device 10 and second operation 300 for the second type computer device 50. For the first operation 200, at block 202, the first type computer device 10 which is a client computer detects a plug-in of the client computer 10 to the second type computer device 50 which is a dock computer. When the client computer 10 detects that it is connected to the dock computer 50, at block 204 of the first operation 200, the client computer 10 outputs video and audio information of the client computer 10 to the panel 502 and speaker 504 of the dock computer 50. Then at block 206 the client computer 10 detects whether there is a USB link between USB of the client computer 10 and USB of the dock computer 50. If there is a USB link, the USB interface 106 of the client computer 10 is linked to the USB hub 506 at block 208. If there is no USB link, the first operation 200 moves to block 209; at block 209 the client computer 10 detects whether the embedded controller 108 of the client computer 10 can be linked to the embedded controller 508 of the dock computer 50. If the answer is positive, at block 210, the EC 108 of the client computer 10 is linked to the EC 508 of the dock computer 50. After block 210, the ECs 108, 508 communicate with each other to decide which USB sensor, if any, is used as a sensor for the connected client and dock computers 10, 50 at block 212. Then at block 214 the ECs 108, 508 communicate with each other to decide which I2C sensor, if any, is used as a sensor for the connected client and dock computers 10, 50. After block 214, at block 216 the first operation 200 is ended. Alternatively, if there is no EC link available at block 209, the first operation 200 of the client computer 10 is directly ended at block 216. Still alternatively, after block 208 at which the USB interface 106 of the client computer 10 is connected to the USB hub 506 of the dock computer 50, the first operation 200 is moved to block 209 to proceed with the first operation 200 therefrom.

For the second operation 300, at block 302, the dock computer 50 detects the plug-in of the client computer 10 to the dock computer 50. When the dock computer 50 detects that it is connected with the client computer 10, at block 304 the dock computer 50 sinks the video and audio information of the client computer 10 to the panel 502 and speaker 504 of the dock computer 50. Then at block 306 the dock computer 50 detects whether the USB of the client computer 10 is linked to the USB of the dock computer 50. If the answer is positive, the USB hub 506 of the dock computer 50 is linked to the USB interface 106 of the client computer 10 at block 208. If there is no USB link, the second operation 300 moves to block 309; at block 309 the dock computer 50 detects whether the embedded controller 508 of the dock computer 50 can be linked to the embedded controller 108 of the client computer 50. If there is a link available, at block 210, the EC 508 of the dock computer 50 is linked with the EC 108 of the client computer 10. After block 210, the ECs 108, 508 communicate with each other to decide which one of the USB sensors 110, 510 is used as a sensor for the connected client and dock computers 10, 50 at block 212. Then at block 214 the ECs 108, 508 communicate with each other to decide which one of the I2C sensors 112, 512 is used as a sensor for the connected client and dock computers 10, 50. After block 214, at block 216 the second operation 300 is ended. Alternatively, if there is no EC link available at block 309, the second operation 300 of the dock computer 50 is directly ended at block 216. Still alternatively, after block 208 at which the USB interface 106 of the client computer 10 is connected to the USB hub 506 of the dock computer 50, the second operation 300 is moved to block 309 to proceed with the second operation 300 therefrom.

It is to be understood that the above-described embodiments are intended to illustrate rather than limit the disclosure. Variations may be made to the embodiments without departing from the spirit of the disclosure as claimed. The above-described embodiments illustrate the scope of the disclosure but do not restrict the scope of the disclosure.

What is claimed is:

1. A system of two connected computation devices comprising:
a dock computation device comprising a display and a first embedded controller;
a client computation device comprising a display interface and a second embedded controller; and
at least a sensor located in at least one of the dock computation device and the client computation device;
wherein the client and dock computation devices are coupled together through mated connectors; and
wherein the first and second embedded controllers are communicatively coupled with each other and configured to determine a use of the at least a sensor as a sensor of the system.

2. The system of claim 1, wherein the dock computation device is a display device and the at least a sensor is located in the client computation device.

3. The system of claim 2, wherein computation of the system is executed by the client computation device.

4. The system of claim 1, wherein the dock computation device is a computer with a display device and computation of the system is executed by the dock computation device.

5. The system of claim 4, wherein the at least a sensor is located in the dock computation device when the at least a sensor is a camera sensor.

6. The system of claim 5, wherein the camera sensor is a USB (universal serial bus) camera sensor.

7. The system of claim 4, wherein the at least a sensor is a located in the client computation device when the sensor is a gravity sensor.

8. The system of claim 7, wherein the gravity sensor is an I2C (inter-integrated circuit) gravity sensor.

9. The system of claim 1, wherein the dock computation device is portable device, computation of the system is executed by the client computation device and the at least a sensor is located in the dock computation device.

10. The system of claim 9, wherein the at least a sensor comprises at least a camera sensor and a gravity sensor.

11. The system of claim 10, wherein the at least a camera sensor comprises an I2C camera sensor and the gravity sensor is an I2C gravity sensor.

12. A method of connecting a dock computation device and a client computation device together comprising:
connecting a connector of the client computation device to a connector of the dock computation device;
sinking video and audio information from the client computation device to the dock computation device;
linking universal serial buses (USBs) of the dock computation device and the client computation device together if there are USBs in both the dock and client computation devices; and
linking embedded controllers (ECs) of the dock computation device and the client computation devices together if there are ECs in both the dock and client computation devices;
wherein the ECs determine use of at least a sensor in at least one of the dock computation device and the client computation device as a sensor for the connected dock and client computation devices.

13. The method of claim 12, wherein when the dock computation device is a display device, the at least a sensor is a sensor of the client computation device.

14. The method of claim 12, wherein when the dock computation device is a computer with a display device which has a calculation capability larger than a calculation capability of the client device, the at least a sensor is a sensor of the client computation device and the at least a sensor is used to detect an acceleration of the client device.

15. The method of claim 12, wherein when the dock computation device is a portable computation device with a display, the at least a sensor is in the dock computation device and the at least a sensor comprises a gravity sensor and a camera sensor.
